(19) United States
(12) Patent Application Publication
(10) Pub. No.: US 2010/0242763 A1
(43) Pub. Date: Sep. 30, 2010

(54) Backup Mechanism for Irradiation Time Data of a Drying Device in Printing Press

(75) Inventor: Takahiko Nakamura, Fuchu-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: Ryobi Ltd., Fuchu-shi (JP)

(21) Appl. No.: 12/731,624

(22) Filed: Mar. 25, 2010

(30) Foreign Application Priority Data
Mar. 26, 2009 (JP) 2009-075511

(51) Int. Cl. B41L 23/20

(52) U.S. Cl. 101/424.1

(57) ABSTRACT

An object is to provide a drying device of a printing press that is capable of securely storing the integrated values of the irradiation times of LEDs and notifying the operator of the replacement timing of the LEDs. Two control parts are provided to control operation of the printing press. The two control parts each store and update integrated values of the irradiation times of the LEDs on one-by-one basis or on a group-by-group basis automatically or arbitrarily, and compare and update the integrated values of one of the two control parts with the integrated values of the remaining control part to keep each of the integrated values of both the control parts update with the latest integrated value.

### CROSS REFERENCE TO RELATED APPLICATION

This application claims priority from Japanese Patent Application No. 2009-075511, which is incorporated herein by reference.

### BACKGROUND OF THE INVENTION

1. Field of the Invention

The present invention relates to a printing press that includes a drying device using light emitting diodes (LEDs) to dry an ultraviolet curable paint applied on sheets of paper. More specifically, the present invention relates to a backup mechanism for data representative of irradiation times of LEDs in a drying device. In the present invention, by the paint is meant to include not only ink but also varnish for use to provide protection or glossy finish to the surface of a printed matter previously printed with ink.

2. Related Art

In these years, a drying device for irradiating ultraviolet (UV) rays is used for the printing press industry. This type of drying device recently draws attention for the reason that it has low heat generation compared with a drying device using a conventional high pressure mercury lamp or xenon lamp as a light source, and has a long operation life. The Japanese Patent Application Laid-open No. 2008-207369 discloses a drying device of a printing press using LEDs.

### SUMMARY OF THE INVENTION

According to a preferable type of drying device using LEDs, the irradiation times of LEDs are integrated and stored, the integrated value once reaches a value corresponding to a preset replacement timing, notification is made to an operator. However, the drying device using LEDs has a long operation time and therefor there is a case in which a personal computer or the like for storing integrated value of the irradiation times is likely to first break down, which causes unsecured storage of the integrated value. Hence, there is a room for improvement and the aforesaid Japanese Patent Application Laid-open No. 2008-207369 neither teaches nor suggests such improvement.

The present invention was conceived to solve the above problem. An object of the present invention is to provide a drying device of a printing press that is capable of securely storing the integrated values of the irradiation times of LEDs and notifying the operator of the replacement timing of the LEDs.

According to the present invention, there is provided a backup mechanism for irradiation time data of a drying device in a printing press, the drying device for drying and curing a UV curable paint on sheets of paper by irradiating the sheets of paper on a drying cylinder 11 with UV rays of LEDs 13, the backup mechanism including at least two control parts 21, 22 for controlling operation of the printing press, wherein the at least two control parts 21, 22 each store and update integrated values of the irradiation times of the LEDs 13 on one-by-one basis or on a group-by-group basis automatically or arbitrarily, and compare and update the integrated values of one of the at least two control parts with the integrated values of the remaining control part to keep each of the integrated values of both the control parts 21, 22 update with the latest integrated value.

Thus, according to the aforesaid backup mechanism for irradiation time data of the drying device of the printing press, the at least two control parts compare the integrated values of the irradiation times of the LEDs with each other so as to update the integrated values with latest values. With this mechanism, it is possible to securely store the latest integrated values of the irradiation times of the LEDs, thus enabling the operator to be informed of the correct replacement timing of the LEDs even if any one of the control parts breaks down.

### BRIEF DESCRIPTION OF THE DRAWINGS

The above, and other objects, features and advantages of the present invention will become apparent from the detailed description thereof in conjunction with the accompanying drawings wherein.

FIG. 1 is a schematic side view of a printing press equipped with a drying device of the present invention;

FIG. 2A is a perspective view showing the positional relationship between a drying cylinder and LEDs, and FIG. 2B is a front view of mounting bases with LEDs mounted therein.

FIG. 3 is a block diagram showing the structure of control devices.

FIG. 4 is a flowchart of a backup mechanism.

FIG. 5 is a front view showing a display screen of a monitor.

### DESCRIPTION OF THE PREFERRED EMBODIMENTS

Now, the description will be made for an embodiment of the present invention with reference to the drawings attached hereto.

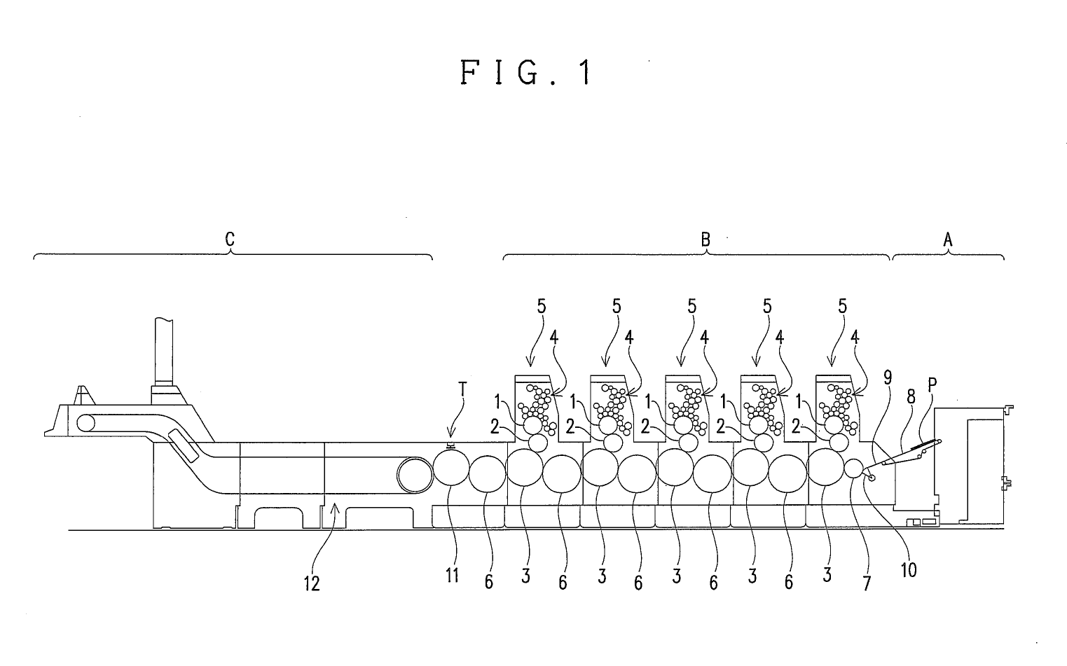

FIG. 1 shows one example of a printing press equipped with a drying device of the present invention. As shown in the schematic side view of FIG. 1, a printing press of this embodiment is a sheet offset printing press. This printing press includes a sheet feeding section A for feeding out sheets of paper P (also simply referred to as sheets P) as printing sheet of paper one by one from a sheet stack table by a feeder device or a sheet separation device, a printing section B for printing on the sheets P fed from the sheet feeding section A, and a sheet discharge device C for discharging the sheets P. Although the printing section B includes five printing units 5 to perform five-color printing in this embodiment, a printing section may be designed to be capable of printing other colors than five colors, such as a single color or more than one colors. In addition, while the sheet discharge device C is constructed of a chain conveyor device with grippers, the printing press may not include the sheet discharge section C, and the specific structure of each section constituting the printing press is not limited to that shown in the figure.

The printing units 5 each include a plate cylinder 1, a rubber cylinder 2, an ink roller group 4, an impression cylinder 3 and a delivery cylinder 6. Although not shown in the figure, each of the impression cylinders 3 and the delivery cylinders 6 is provided with grippers, each having a jaw block and a gripping jaw to grip a fed sheet P, at two positions (one gripper may be provided at a single position or more than two grippers may be provided at more than two positions) in a circumferential direction. A reference numeral 7 represents a sheet feeding cylinder and functions to receive from a swing arm 10 each of the sheets P conveyed on a feeder board 8 and a port plate 9, and deliver the same to the impression cylinder 3. The sheet feeding cylinder 7 and the swing arm 10 each are also provided with a jaw block and a gripping jaw.

A drying section is provided between the most downstream one of the printing units 5 of the printing section and the sheet discharge device C. Specifically, the sheets P conveyed by the impression cylinder 3 of the most downstream printing unit 5 are delivered to the delivery cylinder 6. Then, the sheets P are delivered from the delivery cylinder 6 to a drying cylinder 11. A drying device T is disposed above the drying cylinder 11.

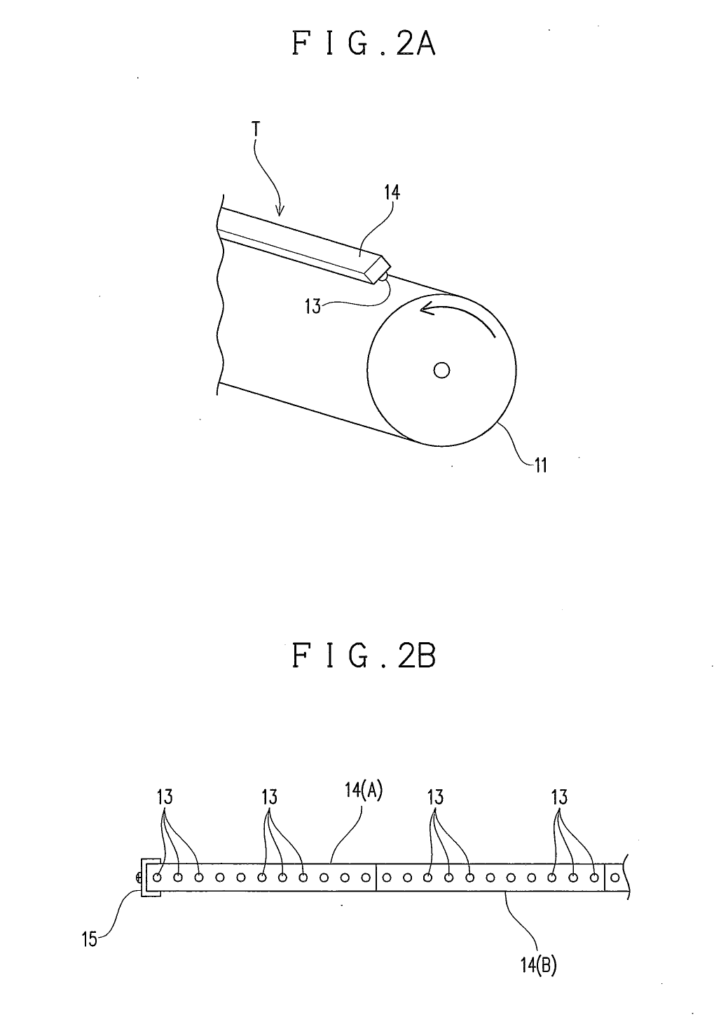

The drying device T is specifically an ultraviolet ray irradiation part, and, as shown in FIGS. 2A and 2B, sixty six LEDs 13 with an irradiation axis substantially orthogonal to the surface of the drying cylinder 11 are mounted in the drying device T and disposed above the drying cylinder 11, as well. The LEDs 13 are aligned in one line along a width direction of the sheets P (an axial direction of the drying cylinder 11) with a predetermined interval (an equal interval in this embodiment) so as to irradiate the entire width of the drying cylinder with UV rays.

Of these sixty six LEDs 13, every eleven LEDs 13 are mounted in one elongated mounting base 14, and six mounting bases 14 in total are jointed to each other in a direction corresponding to the width of the sheets P (or the axial direction of the drying cylinder 11), and supporting members 15 are respectively mounted to outer ends of the most outer mounting bases 14 (in FIG. 2B, only the one outer end is shown), and the six mounting bases 14 jointed together are supported by the opposite supporting members 15, 15 with a predetermined distance from the surface of the drying cylinder 11. Reference codes A-F are allocated respectively to the six mounting bases 14 (in FIG. 2B, only the mounting bases 14(A) and 14(B) are shown).

The sheets P printed at the printing section B are delivered from the impression cylinder 3 of the most downstream printing unit 5 to the delivery cylinder 6, and the printed surfaces of the sheets P are successively brought into contact with the delivery cylinder 6 and thereby inks satisfactorily settle on the sheets P. Then, the sheets P delivered from the delivery cylinder 6 to the drying cylinder 11 are dried at the drying device T, and then delivered to the chain conveyor device 12 of the sheet discharge device C. Thus, the sheets P printed in this matter are unlikely to lose glossy surface, and can be finished with good quality.

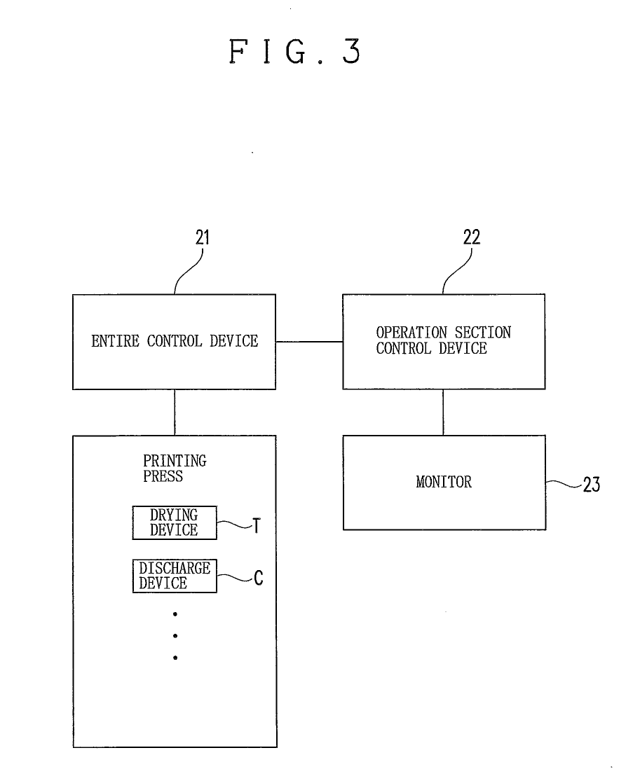

FIG. 3 is a block diagram showing the structure of the control device. The printing press with the aforesaid drying device T, the discharge device C, etc., is connected to an entire control device 21. The entire control device 21 performs control of the entire operation of the printing press. The entire control device 21 is connected to an operation section control device 22. The operation section control device 22 is connected to a touch panel monitor 23, and is structured to give instructions for various operations of the printing press to the printing press via the entire control device 21 by touching the monitor 23. The entire control device 21 and the operation section control device 22 are both capable of storing integrated values of the irradiation times (ON-times) of the LEDs.

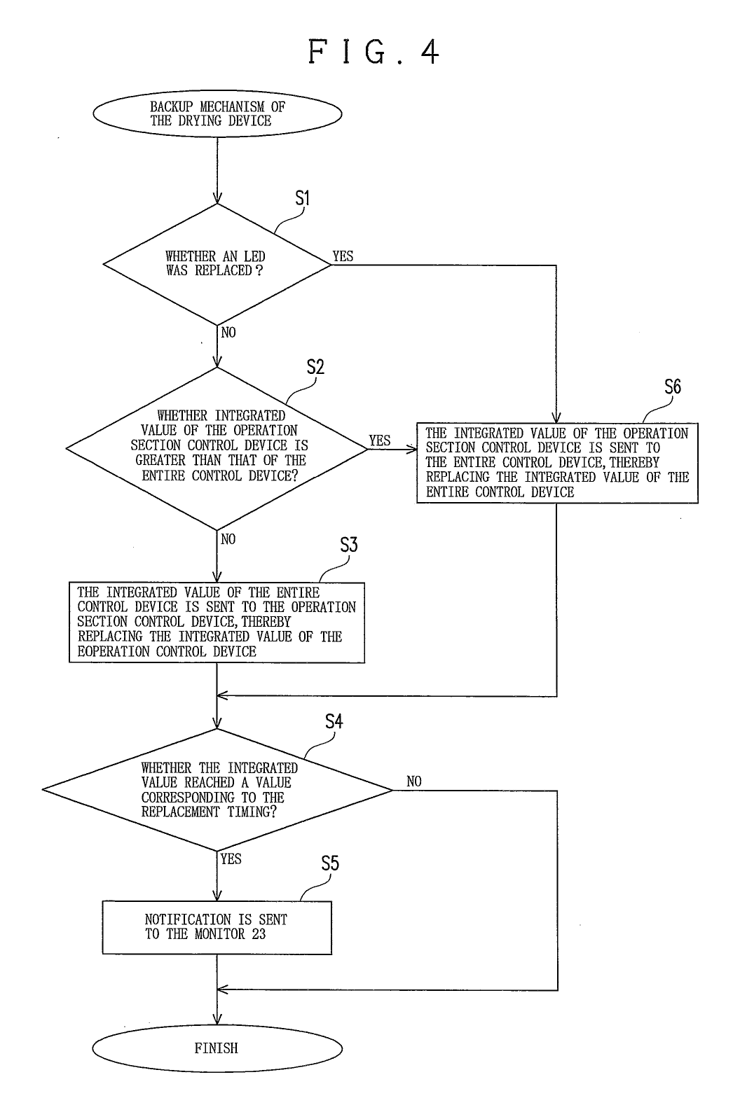

Now, the description will be made for the operation of the backup mechanism of the drying device of the printing press having the above structure with reference to the flowchart of FIG. 4. In this embodiment, the backup operation is made automatically or every time the power is activated, but may be made arbitrarily or at any timing. In this operation, the irradiation times are integrated for the LEDs 13 on one by one basis. However, it is to be noted that the irradiation times may be integrated for the LEDs 13 on a group by group basis, which will be mentioned later.

First, a check is made on whether the LEDs 13 on the mounting bases 14 have been replaced with new ones (Step S1). The LEDs 13 are not frequently replaced and therefore the operation usually proceeds to Step S2, in which a check is made on whether the integrated value of the irradiation times of each of the LEDs 13 stored in the operation section control device 22 is greater than the integrated value of the entire control device 21 or not. When the integrated value of the entire operation device 21 is greater than that of the operation section control device 22, the integrated value of the entire control device 21 is sent to the operation section control device 22, thereby replacing the integrated value of the operation section control device 22 with the integrated value of the entire control device 21 (Step S3); and when the integrated value of the operation section control device 22 is greater than that of the entire control device 21, the integrated value of the operation section control device 22 is sent to the entire control device 21, thereby replacing the integrated value of the entire control device 21 with the integrated value of the operation section control device 22 (Step S6).

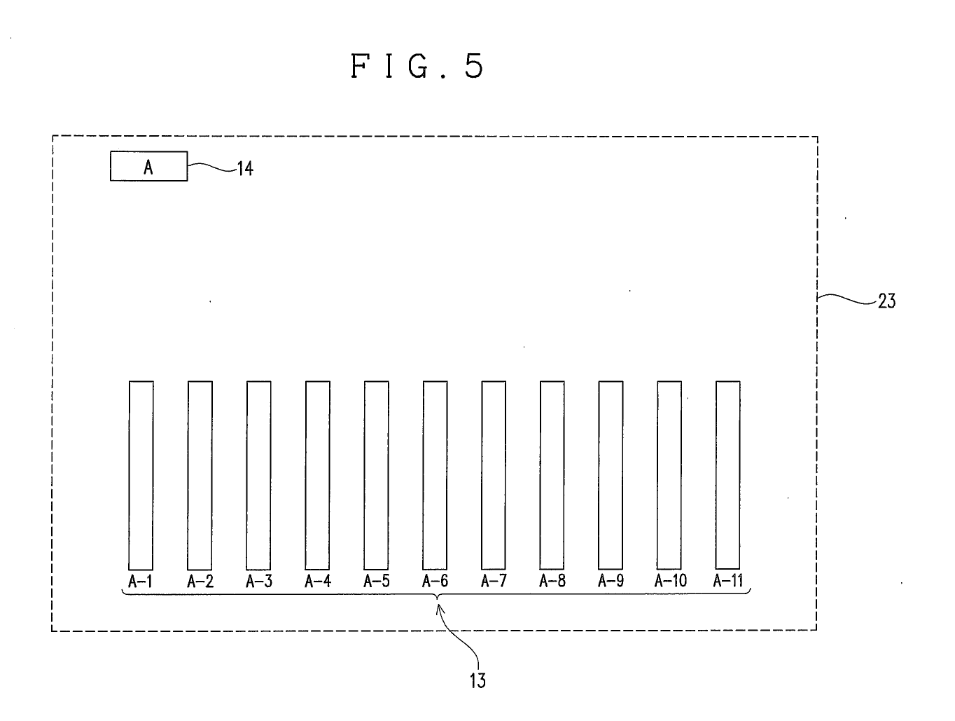

Then, when the integrated value reaches a value corresponding to a preset replacement timing (Step S4), the operator is notified of the necessity to replace the corresponding one of the LEDs 13 with new a new one (Step S5). The integrated value corresponding to the replacement timing of each of the LEDs 13 is set at 12,000 hours in this embodiment. Specifically, the monitor 23 displays the LEDs 13 one by one. In FIG. 5, of the six mounting bases 14, the eleven LEDs 13 mounted on the left end mounting base 14(A) are displayed. At the upper left side of the screen, the corresponding code (A, B, C . . . , or F) of the mounting base 14 to be monitored, which codes being allocated to the respective mounting bases 14, is displayed. The eleven LEDs 13 are respectively displayed with the representations of A-1 . . . , and A-11 with or without any images (in this embodiment, with vertical column images), and the corresponding code(s) with or without such image(s) of an LED(s) 13 changes in color or blinks, enabling the operator to be notified of the replacement timing. Thus, the integrated value of the irradiation times is stored for every individual LED 13.

When the corresponding one of the LED(s) 13 has been replaced with a new one on any one of the mounting bases 14, the information representative of this fact, that is, the integrated value of 0, is inputted into the operation section control device 22. Thus, when the replacement of an LED 13 is made on any of the mounting bases 14 (Step S1), the corresponding integrated value of the operation section control device 22 is absolutely or unconditionally sent to the entire control device 21 even if the entire control device 21 stores a greater integrated value for this LED 13, and thereby the integrated value of the entire control device 21 is replaced with “0” (Step S6).

Thus, both the control devices update with each other's integrated values (correct integrated values), and therefore, even if one of the control devices breaks down, the remaining control device still stores the latest integrated values, so that, after the control device has been repaired, the integrated values stored in the remaining control device are sent to the repaired control device to reflect the latest values therein. Thus, it is possible to securely manage the replacement timings of the LEDs. Since an LED has a long operation life, it is likely that any of the control devices breaks down earlier than the LED, and therefore it is preferable that the control devices update with each other's integrated values.

It is to be noted that the present invention is not necessarily limited to this embodiment, and may be subjected to various modifications within the intended scope of the invention. For example, the integrated value of each of the LEDs is managed in the above embodiment, but, when the ON-OFF control is made for every mounting base 14, the integrated value is managed for the LEDs 13 of every mounting base 14, that is, on a group by group basis, which contributes to simplified operation of the control devices. In the above embodiment, the present invention is applied to a sheet offset printing press without intention to limit the present invention thereto, and accordingly the present invention may be applied to an inkjet printing press, a flexo printing press, etc.

In order to update the integrated values stored in the control devices with the latest integrated values (correct integrated values), comparing in integrated values between the entire control device 21 and the operation section control device 22 is made. This comparing operation may be made by any one of the entire control device 21 and the operation section control device 22. Specifically, when the entire control device 21 performs this comparing operation, the entire control device 21 receives the information of the integrated values from the operation section control device 22 and compares the received integrated values with its stored integrated values, so that, when the entire control device 21 has a greater integrated value, it sends this integrated value to the operation section control device 22. When the operation section control device 22 performs the comparing operation, the subsequent operation mentioned above is performed in the reverse way. Alternatively, both the entire control device 21 and the operation section control device 22 may perform the comparing operation.

Thus, the backup mechanism for irradiation time data is remarkably useful for a printing press having a drying device.

This specification is by no means intended to restrict the present invention to the preferred embodiments set forth therein. Various modifications to the backup mechanism for irradiation time data of a drying device in a printing press, as described herein, may be made by those skilled in the art without departing from the spirit and scope of the present invention as defined in the appended claims.

What is claimed is:

1. A backup mechanism for irradiation time data of a drying device in a printing press, the drying device for drying and curing a UV curable paint on sheets of paper by irradiating the sheets of paper on a drying cylinder with UV rays of LEDs, the backup mechanism comprising at least two control parts for controlling operation of the printing press, wherein the at least two control parts each store and update integrated values of the irradiation times of the LEDs on one-by-one basis or on a group-by-group basis automatically or arbitrarily, and compare and update the integrated values of one of the at least two control parts with the integrated values of the remaining control part to keep each of the integrated values of both the control parts update with the latest integrated value.
